(19) United States
(12) Patent Application Publication
(10) Pub. No.: US 2021/0189034 A1
(43) Pub. Date: Jun. 24, 2021

(54) POLYMER PARTICLES, RUBBER COMPOSITION AND TIRE

(71) Applicant: Toyo Tire Corporation, Itami-shi (JP)

(72) Inventor: Satoshi Fukunishi, Itami-shi (JP)

(73) Assignee: Toyo Tire Corporation, Itami-shi (JP)

(21) Appl. No.: 17/110,770

(22) Filed: Dec. 3, 2020

(30) Foreign Application Priority Data
Dec. 18, 2019 (JP) 2019-228502

(51) Int. Cl. C08F 220/12; C08L 9/00; C08L 33/10; B60C 1/00; B60C 11/00

(52) U.S. Cl. CPC C08F 220/12; C08L 9/00; B60C 2011/0025; B60C 1/0016; B60C 11/0008; C08L 33/10

(57) ABSTRACT

Polymer particles according to an embodiment includes a (meth)acrylate polymer having a constituent unit represented by the following formula (1) and having a chemically crosslinked structure containing an ether bond or a siloxane bond:

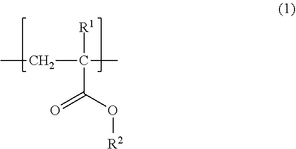

wherein R¹ is a hydrogen atom or a methyl group, and R² is an alkyl group having 4 to 18 carbon atoms.

### CROSS-REFERENCE TO RELATED APPLICATIONS

This application is based upon and claims the benefit of priority from the prior Japanese Patent Application No. 2019-228502, filed on Dec. 18, 2019; the entire contents of which are incorporated herein by reference.

### BACKGROUND

### 1. Technical Field

The present invention relates to polymer particles, and to a rubber composition and a tire using the polymer particles.

### 2. Description of Related Art

These days, tires are required to be improved both in the grip performance on a wet road surface (wet grip performance) and in the rolling resistance performance contributing to low fuel consumption. However, to increase the tan δ at 0° C. of a rubber composition, which is an index of the wet grip performance, and to decrease the tan δ at 60° C. of the rubber composition, which is an index of the rolling resistance performance, conflict with each other; thus, it is difficult to simultaneously improve these properties. A need therefore exists to improve such conflicting viscoelastic properties.

JP-A-H09-328577, for the purpose of enhancing the wet grip performance of a tire without substantially impairing the rolling resistance of the tire, has proposed adding to a diene rubber a copolymer resin comprising a C5 fraction, obtained by cracking of naphtha, and styrene or vinyl toluene.

JP-A-2017-110069 and JP-A-2019-112560, for the purpose of enhancing the wet grip performance while preventing a deterioration in the rolling resistance performance, have proposed adding, to a rubber component composed of a diene rubber, polymer particles having a glass transition point of −70 to 0° C. and composed of a meth(acrylate) polymer having a particular constituent unit and having a chemically crosslinked structure. However, no study is made on the crosslinked structure in these documents, and there is room for improvement in the rolling resistance performance and the wet grip performance.

### SUMMARY

It is therefore an object of an embodiment of the present invention to provide polymer particles which can improve the conflicting viscoelastic properties, i.e. increase the tan δ at 0° C. and decrease the tan δ at 60° C. It is also an object of an embodiment of the present invention to provide a rubber composition which, when used for a tire, can improve the balance between the wet grip performance and the rolling resistance performance, and to provide a tire using the rubber composition.

In one embodiment, the present invention provides polymer particles comprising a (meth)acrylate polymer having a constituent unit represented by the following general formula (1) and having a chemically crosslinked structure containing an ether bond or a siloxane bond:

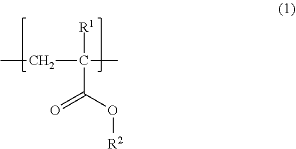

wherein R¹ represents a hydrogen atom or a methyl group, and R¹s in the same molecule may be the same as or different from each other; and R² represents an alkyl group having 4 to 18 carbon atoms, and R²s in the same molecule may be the same as or different from each other.

In another embodiment, the present invention provides a rubber composition comprising 100 parts by mass of a rubber component comprising a diene rubber, and 1 to 100 parts by mass of the polymer particles.

In yet another embodiment, the present invention provides a tire comprising a tread rubber comprising the rubber composition.

### DESCRIPTION OF EMBODIMENTS

Embodiments of the present invention will now be described in detail.

[Polymer Particles]

Polymer particles according to an embodiment are fine particles comprising a (meth)acrylate polymer having an alkyl (meth)acrylate unit, represented by the following general formula (1), as a constituent unit (also called a repeating unit). As used herein, the term “(meth)acrylate” refers to one or both of an acrylate and a methacrylate.

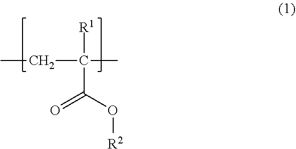

wherein R¹ is a hydrogen atom or a methyl group, and R¹s existing in the same molecule may be the same as or different from each other; and R² is an alkyl group having 4 to 18 carbon atoms, and R²s existing in the same molecule may be the same as or different from each other. The alkyl group of R² may be either linear or branched. R² is preferably an alkyl group having 6 to 16 carbon atoms, more preferably an alkyl group having 8 to 15 carbon atoms.

The (meth)acrylate polymer is produced by polymerization of a monofunctional vinyl monomer comprising a (meth)acrylate represented by the following general formula (3). As used herein, the term “monofunctional vinyl monomer” refers to a polymerizable monomer having one vinyl group in the molecule. The term “vinyl group”, as used herein, does not mean the strict-sense vinyl group (H₂C═CH—), and means a broad-sense vinyl group including a vinylidene group (H₂C═CX—) and a vinylene group (—HC═CH—).

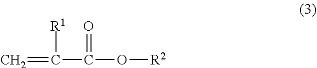

wherein R¹ and R² are the same as the R¹ and R² of the formula (1). Thus, R¹ is a hydrogen atom or a methyl group. R² is an alkyl group having 4 to 18 (preferably 6 to 16, more preferably 8 to 15) carbon atoms, and may be either linear or branched.

Examples of the (meth)acrylate include n-alkyl (meth)acrylates such as n-butyl acrylate, n-pentyl acrylate, n-hexyl acrylate, n-heptyl acrylate, n-octyl acrylate, n-nonyl acrylate, n-decyl acrylate, n-undecyl acrylate, n-dodecyl acrylate, n-tridecyl acrylate, n-butyl methacrylate, n-pentyl methacrylate, n-hexyl methacrylate, n-heptyl methacrylate, n-octyl methacrylate, n-nonyl methacrylate, n-decyl methacrylate, n-undecyl methacrylate, and n-dodecyl methacrylate; isoalkyl (meth)acrylates such as isobutyl acrylate, isopentyl acrylate, isohexyl acrylate, isoheptyl acrylate, isooctyl acrylate, isononyl acrylate, isodecyl acrylate, isoundecyl acrylate, isododecyl acrylate, isotridecyl acrylate, isotetradecyl acrylate, isobutyl methacrylate, isopentyl methacrylate, isohexyl methacrylate, isoheptyl methacrylate, isooctyl methacrylate, isononyl methacrylate, isodecyl methacrylate, isoundecyl methacrylate, isododecyl methacrylate, isotridecyl methacrylate, and isotetradecyl methacrylate; 2-methylbutyl acrylate, 2-ethylpentyl acrylate, 2-methylhexyl acrylate, 2-ethylhexyl acrylate, 2-ethylheptyl acrylate, 2-methylpentyl methacrylate, 2-methylhexyl methacrylate, 2-ethylhexyl methacrylate, and 2-ethylheptyl methacrylate. These compounds may be used either singly or in a combination of two or more kinds thereof.

As used herein, the term “(meth)acrylic acid” refers to one or both of acrylic acid and methacrylic acid. The term “isoalkyl” refers to an alkyl group having a methyl side chain on the second carbon atom from the end of the alkyl chain. For example, “isodecyl” refers to an alkyl group having 10 carbon atoms, which has a methyl side chain on the second carbon atom from the end of the alkyl chain, and conceptually includes not only an 8-methylnonyl group but a 2,4,6-trimethylheptyl group as well.

In one embodiment, the (meth)acrylate polymer preferably has, as the constituent unit represented by the formula (1), a constituent unit represented by the following general formula (4):

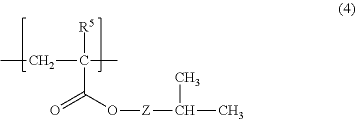

wherein R^{b} represents a hydrogen atom or a methyl group (preferably a methyl group), and R⁵s in the same molecule may be the same as or different from each other. Z represents an alkylene group (i.e. an alkanediyl group) having 1 to 15 carbon atoms, and Zs in the same molecule may be the same as or different from each other. Z may be either linear or branched. Z is preferably an alkylene group having 5 to 12 carbon atoms, more preferably an alkylene group having 6 to 10 carbon atoms.

The constituent unit (4) is derived from a (meth)acrylate represented by the following general formula (5). Therefore, the (meth)acrylate represented by the general formula (3) preferably comprises a (meth)acrylate represented by the general formula (5). A (meth)acrylate polymer according to an embodiment is produced by polymerization of a monofunctional vinyl monomer comprising a (meth)acrylate represented by the general formula (5). The (meth)acrylate represented by the general formula (5) can be exemplified by the above-listed isoalkyl (meth)acrylates.

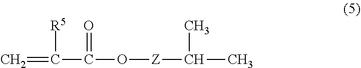

wherein R⁵ and Z are the same as the R⁵ and Z of the formula (4). Thus, R⁵ represents a hydrogen atom or a methyl group (preferably a methyl group). Z represents an alkylene group having 1 to 15 (preferably 5 to 12, more preferably 6 to 10) carbon atoms, and may be either linear or branched.

In this embodiment, the (meth)acrylate polymer has a chemically crosslinked structure containing an ether bond or a siloxane bond. The use of such a (meth)acrylate polymer makes it possible Lo improve the above-described conflicting viscoelastic properties. In particular, it becomes possible to decrease the tan δ at 60° C. while enhancing the effect of increasing the tan δ at 0° C. As used herein, the term “ether bond” refers to a C—O—C bond in a structure in which an oxygen atom is bonded to two hydrocarbon groups. The term “siloxane bond” refers to a bond represented by Si—O—Si. In one embodiment, the crosslinked structure preferably comprises a polyether structure having a repetition of ether bonds. In one embodiment, the crosslinked structure preferably comprises a polysiloxane structure having a repetition of siloxane bonds.

The crosslinked structure preferably comprises a structure represented by the following general formula (2):

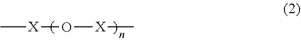

wherein X represents an alkylene group (i.e. an alkanediyl group) having 2 to 6 carbon atoms, or —SiR³R⁴—, and Xs in the same molecule may be the same as or different from each other. R³ and R⁴ each independently represent a hydrogen atom or an alkyl group having 1 to 3 carbon atoms.

When X is an alkylene group, the crosslinked structure contains an ether bond, and the alkylene group may be either linear or branched. Alkylene groups in one crosslinked structure may be the same as or different from each other. The alkylene group preferably has 2 to 4 carbon atoms. Examples of the alkylene group include an ethylene group, a propylene group, a trimethylene group, and a tetramethylene group. These groups may be used either singly or in a combination of two or more kinds thereof.

When X is —SiR³R⁴—, the crosslinked structure contains a siloxane bond. Ras and R⁴s in one crosslinked structure may respectively be the same as or different from each other. The alkyl group of each of R³ and R⁴ may be either linear or branched, and preferably has 1 or 2 carbon atoms, and more preferably is a methyl group.

n in the formula (2) is the number of repetitions of —O—X—, and is an integer of 1 to 35. When X is an alkylene group, n is preferably 1 to 20, more preferably 2 to 15. When X is —SiR³R⁴—, n is preferably 5 to 35, more preferably 15 to 30.

The crosslinked structure containing an ether bond or a siloxane bond is preferably formed by using a polyfunctional vinyl monomer having, in the molecule, an ether bond or a siloxane bond and at least two vinyl groups capable of free radical polymerization. More preferably, the crosslinked structure is formed by using a polyfunctional vinyl monomer having, in the molecule, a structure represented by the formula (2) and at least two vinyl groups capable of free radical polymerization. Thus, a (meth)acrylate polymer according to an embodiment preferably comprises, together with the constituent unit represented by the general formula (1), a constituent unit derived from the polyfunctional vinyl monomer having an ether bond or a siloxane bond, and has a crosslinked structure in which the constituent unit derived from the polyfunctional vinyl monomer constitutes a crosslinking point.

Examples of polyfunctional vinyl monomers containing an ether bond include polyalkylene glycol di(meth)acrylates such as polyethylene glycol diacrylate, polypropylene glycol diacrylate, polytrimethylene glycol diacrylate, polytetramethylene glycol diacrylate, polyethylene glycol dimethacrylate, polypropylene glycol dimethacrylate, polytrimethylene glycol dimethacrylate, and polytetramethylene glycol dimethacrylate. Examples of polyfunctional vinyl monomers containing a siloxane bond include silicone oils having (meth)acryloyloxy groups at both ends of the molecule, such as a dimethyl silicone oil having acryloyloxy groups at the molecular ends, a methylhydrogen silicone oil having acryloyloxy groups at the molecular ends, a dimethyl silicone oil having methacryloyloxy groups at the molecular ends, and a methylhydrogen silicone oil having methacryloyloxy groups at the molecular ends. These polyfunctional vinyl monomers may be used either singly or in a combination of two or more kinds thereof. As used herein, the term “(meth)acryloyloxy group” refers to one or both of an acryloyloxy group and a methacryloyloxy group.

A polyalkylene glycol di(meth)acrylate, an exemplary polyfunctional vinyl monomer, is represented by the following general formula (6):

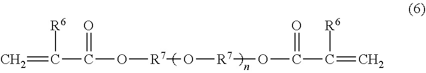

wherein R⁶ represents a hydrogen atom or a methyl group, and R⁶s in the same molecule may be the same as or different from each other. R⁷ represents an alkylene group having 2 to 6 (preferably 2 to 4) carbon atoms, and R⁷s in the same molecule may be the same as or different from each other. n is an integer of 1 to 35, preferably 1 to 20, more preferably 2 to 15.

A silicone oil having (meth)acryloyloxy groups at both ends of the molecule, another exemplary polyfunctional vinyl monomer, is represented by the following general formula (7):

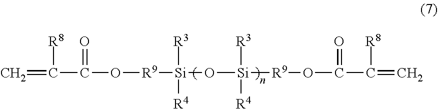

wherein R³ and R⁴ are the same as the R³ and R⁴ of the formula (2). R⁸ represents a hydrogen atom or a methyl group, and R⁰s in the same molecule may be the same as or different from each other. R⁹ represents a divalent organic group linking the (meth)acryloyloxy group with the polysiloxane, and R⁹s in the same molecule may be the same as or different from each other. n is an integer of 1 to 35, preferably 5 to 35, more preferably 15 to 30.

There is no particular limitation on the content of the constituent unit represented by the formula (1) and the content of the constituent unit derived from the polyfunctional vinyl monomer in the (meth)acrylate polymer. For example, the molar ratio of the constituent unit of the formula (1) to all the constituent units constituting the (meth)acrylate polymer is preferably not less than 60 mol %, more preferably not less than 80 mol %, and even more preferably not less than 90 mol %. The upper limit of the molar ratio may be 99.9 mol %, or 99.5 mol %, or 99 mol %. The molar ratio of the constituent unit derived from the polyfunctional vinyl monomer is preferably not less than 0.1 mol %, more preferably not less than 0.5 mol %, even more preferably not less than 1 mol %, and may be not less than 2 mol %. The upper limit of the constituent unit derived from the polyfunctional vinyl monomer may be 20 mol %, or 10 mol %, or 5 mol %. The (meth)acrylate polymer may also comprise a constituent unit(s) derived from other monofunctional vinyl monomer(s).

In one embodiment, when the (meth)acrylate polymer has a constituent unit represented by the formula (4), the molar ratio of the constituent unit of the formula (4) to all the constituent units of the polymer is preferably not less than 25 mol %, more preferably not less than 35 mol %, and may be not less than 50 mol %, or not less than 80 mol %, or not less than 90 mol %. While no particular limitation is placed on the upper limit of the molar ratio, it may be not more than 99.9 mol %, or not more than 99.5 mol %, or not more than 99 mol %.

While no particular limitation is placed on the glass transition point (Tg) of the polymer particles according to this embodiment, it is preferably in the range of −70° C. to 0° C. The glass transition point of not less than −70° C. can enhance the effect of improving the wet grip performance. The glass transition point of not more than 0° C. can prevent deterioration in the rolling resistance performance. The glass transition point can be set or adjusted e.g. through the composition of monomers constituting the polymer. The glass transition point of the polymer particles is preferably not less than −50° C., more preferably not less than −45° C., and is preferably not more than −10° C., more preferably not more than −20° C., and may be not more than −30° C. As used herein, the glass transition point refers to a value as measured by differential scanning calorimetry (DSC) according to JIS K 7121 (temperature increase rate: 20° C./min, temperature measurement range: −150° C. to 150° C.).

While there is no particular limitation on the average particle size of the polymer particles according to this embodiment, it is preferably 10 to 100 nm. The average particle size of the polymer particles is preferably not less than 20 nm, more preferably not less than 30 nm, and is preferably less than 100 nm, more preferably not more than 90 nm, and may be not more than 80 nm. As used herein, the average particle size refers to a particle diameter at a 50% integrated value (D50: 50% diameter) in a particle size distribution obtained by dynamic light scattering (DLS).

There is no particular limitation on a method for producing the polymer particles according to this embodiment; for example, the polymer particles can be synthesized by using known emulsion polymerization techniques. The following is an exemplary preferable method: A monofunctional vinyl monomer comprising a (meth)acrylate represented by the formula (3), together with the polyfunctional vinyl monomer as a crosslinking agent, is dispersed in an aqueous medium, such as water, in which an emulsifier is dissolved. A water-soluble radical polymerization initiator (e.g. a peroxide such as potassium persulfate) is added to the resulting emulsion to initiate radical polymerization. In this manner, fine particles are produced in the aqueous medium. Polymer particles composed of a crosslinked (meth)acrylate polymer are obtained by separating the fine particles from the aqueous medium. The polymer particles can also be produced by using other known polymerization methods such as suspension polymerization, dispersion polymerization, precipitation polymerization, mini-emulsion polymerization, soap-free emulsion polymerization (emulsifier-free emulsion polymerization), and micro-emulsion polymerization.

[Rubber Composition]

A rubber composition according to an embodiment comprises a rubber component composed of a diene rubber, and the above-described polymer particles. The use of the polymer particles can improve the conflicting viscoelastic properties, i.e. increase the tan δ at 0° C. and decrease the tan δ at 60° C. Therefore, the rubber composition, when used for a tire, can enhance the balance between the wet grip performance and the rolling resistance performance.

Examples of the diene rubber as a rubber component include natural rubber (NR), synthetic isoprene rubber (IR), polybutadiene rubber (BR), styrene-butadiene rubber (SBR), nitrile rubber (NBR), chloroprene rubber (CR), butyl rubber (IIR), styrene-isoprene copolymer rubber, butadiene-isoprene copolymer rubber, and styrene-isoprene-butadiene copolymer rubber. These rubbers may be used either singly or in a combination of two or more kinds thereof. Among them, at least one rubber selected from the group consisting of NR, BR and SBR is preferred.

The above-listed exemplary diene rubbers include modified diene rubbers which have been modified, at the molecular end or in the molecular chain, by at least one functional group introduced thereinto after selected from the group consisting of an amino group, a hydroxy group, an alkoxy group, an epoxy group, a silyl group, and a carboxy group. When silica is used as a filler in the rubber composition, the use of a modified diene rubber in the diene rubber can enhance the dispersibility of silica. A modified SBR is preferably used as a modified diene rubber. Thus, a diene rubber according to an embodiment comprises a styrene-butadiene rubber having at least one functional group selected from the group consisting of an amino group, a hydroxy group, an alkoxy group, an epoxy group, a silyl group, and a carboxy group.

In one embodiment, the diene rubber may be a single modified SBR or a blend of a modified SBR and an unmodified diene rubber. For example, the diene rubber may comprise a modified SBR in an amount of not less than 30 parts by mass, or not less than 50 parts by mass per 100 parts by mass of the diene rubber, or may comprise 50 to 90 parts by mass of a modified SBR and 50 to 10 parts by mass of an unmodified diene rubber (e.g. BR and/or NR), or 60 to 90 parts by mass of a modified SBR and 40 to 10 parts by mass of an unmodified diene rubber.

There is no particular limitation on the content of the polymer particles in the rubber composition, and it may be appropriately set depending on the intended use. The content of the polymer particles is preferably 1 to 100 parts by mass, more preferably 2 to 50 parts by mass, even more preferably 3 to 30 parts by mass, and may be 5 to 20 parts by mass per 100 parts by mass of the rubber component consisting of the diene rubber.

Besides the above-described components, the rubber composition according to this embodiment may further contain additives commonly used in rubber compositions, such as a reinforcing filler, a silane coupling agent, zinc oxide, an oil, stearic acid, an antioxidant, wax, a vulcanizing agent, and a vulcanization accelerator.

Silica and/or carbon black is preferably used as the reinforcing filler. More preferably, in order to enhance the balance between the rolling resistance performance and the wet grip performance, silica is used either singly or in combination with carbon black. Wet silica, produced e.g. by a wet precipitation method or a wet gel method, is preferably used.

There is no particular limitation on the amount of the reinforcing filler; for example, it may be 20 to 150 parts by mass, or 30 to 100 parts by mass per 100 parts by mass of the rubber component. There is also no particular limitation on the amount of silica; for example, it may be 20 to 150 parts by mass, or 30 to 100 parts by mass per 100 parts by mass of the rubber component.

In the case of using silica, it is preferred to use it in combination with a silane coupling agent. In that case, the amount of the silane coupling agent is preferably 2 to 20% by mass, more preferably 4 to 15% by mass of the mass of silica.

Sulfur is preferably used as the vulcanizing agent. While there is no particular limitation on the amount of the vulcanizing agent, it is preferably 0.1 to 10 parts by mass, more preferably 0.5 to 5 parts by mass per 100 parts by mass of the rubber component. A variety of vulcanization accelerators, including sulfene amide-type, thiuram-type, thiazole-type and guanidine-type, can be used as the vulcanization accelerator either singly or in a combination of two or more kinds thereof. While there is no particular limitation on the amount of the vulcanization accelerator, it is preferably 0.1 to 7 parts by mass, more preferably 0.5 to 5 parts by mass per 100 parts by mass of the rubber component.

The rubber composition according to this embodiment can be produced by mixing and kneading the components by a common method using a common mixing machine such as a Banbury mixer, a kneader or rolls. Thus, for example, the rubber composition can be prepared by adding the polymer particles and additives, other than a vulcanizing agent and a vulcanization accelerator, to the diene rubber and mixing the components in a first mixing step, and then adding the vulcanizing agent and the vulcanization accelerator to the resulting mixture and mixing the components in a final mixing step.

The thus-obtained rubber composition can be used for various rubber members such as a tire, a rubber vibration insulator, a conveyor belt, etc.

[Tire]

When the rubber composition is used for a tire, it can be applied in various portions, including a tread portion and a side wall portion, of the tire. Preferably, the rubber composition is used for a tread rubber constituting the tread of a tire. Thus, a tire according to an embodiment includes a tread rubber composed of the rubber composition. Examples of the tire include pneumatic tires for various applications and having various sizes, such as tires for passenger cars and heavy-load tires for trucks and buses.

A pneumatic tire can be produced by molding the rubber composition into a tread rubber having a predetermined shape by a common method such as extrusion, combining the tread rubber with other parts to produce a green tire, and then subjecting the green tire to a vulcanization/molding process e.g. at 140 to 180° C.

In one embodiment, the tread rubber of a pneumatic tire may be one having a two-layer structure consisting of a cap rubber and a base rubber, or one having a single-layer structure in which the two rubbers are integrated. In either case, the tread rubber is preferably used for a rubber constituting the tread of the tire. Thus, in the case of a tread rubber having a single-layer structure, the tread rubber is preferably composed of the rubber composition. In the case of a tread rubber having a two-layer structure, the cap rubber is preferably composed of the rubber composition.

### EXAMPLES

The following examples illustrate the present invention in greater detail and are not intended to limit the scope of the invention.

[Average Particle Size Measuring Method]

The average particle size of polymer particles refers to a particle diameter at a 50% integrated value (D50: 50% diameter) in a particle size distribution obtained by dynamic light scattering (DLS). Using latex solutions before coagulation, obtained in the following Synthetic Examples, as measurement samples, measurement of each sample was performed by a photon correlation method (according to JIS Z 8826, the angle between incident light and detector: 90°) using a dynamic light scattering spectrophotometer “DLS-8000” manufactured by Otsuka Electronics Co., Ltd. From the autocorrelation function obtained, the average particle size of polymer particles was determined by the cumulant method.

[Tg Measuring Method]

The glass transition point (Tg) of polymer particles was measured by differential scanning calorimetry (DSC) according to JIS K 7121 (temperature increase rate: 20° C./min, temperature measurement range: −150° C. to 150° C.)

### Synthesis Example 1: Polymer Particles 1 (Comparative)

60 g of 2,4,6-trimethylheptyl methacrylate (i.e., isodecyl methacrylate), 1.576 g of ethylene glycol dimethacrylate, 7.643 g of sodium dodecyl sulfate, 126 g of water and 14 g of ethanol were mixed and stirred for one hour to emulsify the monomer, and 0.717 g of potassium persulfate was added to the emulsion. Thereafter, nitrogen bubbling was performed for one hour, and the solution was held at 70° C. for 8 hours. Methanol was added to the resulting solution to precipitate polymer particles by coagulation, and the polymer particles were dried in a vacuum drier under the conditions of 70° C. and 1.0×10³ Pa to obtain polymer particles 1. The average particle size of the polymer particles 1 was 58 nm, and the Tg was −37° C.

### Synthesis Example 2: Polymer Particles 2 (Comparative)

Polymer particles 2 were produced in the same manner as in Synthesis Example 1 except for using 2.692 g of 1,12-dodecanediol dimethacrylate instead of ethylene glycol dimethacrylate used in Synthesis Example 1. The average particle size of the polymer particles 2 was 56 nm, and the Tg was −35° C.

### Synthesis Example 3: Polymer Particles 3

Polymer particles 3 were produced in the same manner as in Synthesis Example 1 except for using 2.624 g of polyethylene glycol dimethacrylate (“NK Ester 4G” manufactured by Shin-Nakamura Chemical Co. Ltd., having the formula (6) in which R⁶ is a methyl group, R⁷ is an ethylene group, and n is 3) instead of ethylene glycol dimethacrylate used in Synthesis Example 1. The average particle size of the polymer particles 3 was 58 nm, and the Tg was −35° C.

The chemical structure of the polymer of the polymer particles 3 was analyzed by ¹³C-NMR. As a result, it was found that the polymer particles 3 consisted of 97 mol % of a constituent unit derived from the isodecyl methacrylate, and 3.0 mol % of a constituent unit derived from the polyethylene glycol dimethacrylate.

### Synthesis Example 4: Polymer Particles 4

Polymer particles 4 were produced in the same manner as in Synthesis Example 1 except for using 2.445 g of polyethylene glycol diacrylate (“NK Ester A-200” manufactured by Shin-Nakamura Chemical Co. Ltd., having the formula (6) in which R⁶ is a hydrogen atom, R⁷ is an ethylene group, and n is 3) instead of ethylene glycol dimethacrylate used in Synthesis Example 1. The average particle size of the polymer particles 4 was 56 nm, and the Tg was −34° C.

The chemical structure of the polymer of the polymer particles 4 was analyzed by ¹³C-NMR. As a result, it was found that the polymer particles 4 consisted of 97 mol % of a constituent unit derived from the isodecyl methacrylate, and 3.0 mol % of a constituent unit derived from the polyethylene glycol diacrylate.

### Synthesis Example 5: Polymer Particles 5

Polymer particles 5 were produced in the same manner as in Synthesis Example 1 except for using 5.853 g of polyethylene glycol dimethacrylate (“NK Ester 14G” manufactured by Shin-Nakamura Chemical Co. Ltd., having the formula (6) in which R⁶ is a methyl group, R⁷ is an ethylene group, and n is 13) instead of ethylene glycol dimethacrylate used in Synthesis Example 1. The average particle size of the polymer particles 5 was 60 nm, and the Tg was −37° C.

The chemical structure of the polymer of the polymer particles 5 was analyzed by ¹³C-NMR. As a result, it was found that the polymer particles 5 consisted of 97 mol % of a constituent unit derived from the isodecyl methacrylate, and 3.0 mol % of a constituent unit derived from the polyethylene glycol dimethacrylate.

### Synthesis Example 6: Polymer Particles 6

Polymer particles 6 were produced in the same manner as in Synthesis Example 1 except for using 5.630 g of polyethylene glycol diacrylate (“NK Ester A-600” manufactured by Shin-Nakamura Chemical Co. Ltd., having the formula (6) in which R⁶ is a hydrogen atom, R⁷ is an ethylene group, and n is 13) instead of ethylene glycol dimethacrylate used in Synthesis Example 1. The average particle size of the polymer particles 6 was 62 nm, and the Tg was −39° C.

The chemical structure of the polymer of the polymer particles 6 was analyzed by ¹³C-NMR. As a result, it was found that the polymer particles 6 consisted of 97 mol % of a constituent unit derived from the isodecyl methacrylate, and 3.0 mol % of a constituent unit derived from the polyethylene glycol diacrylate.

### Synthesis Example 7: Polymer Particles 7

Polymer particles 7 were produced in the same manner as in Synthesis Example 1 except for using 11.42 g of a dimethyl silicone oil having methacryloyloxy groups at the molecular ends (“X-22-164” manufactured by Shin-Etsu Chemical Co., Ltd., having the formula (7) in which R³ and R⁴ are each a methyl group, and Re is a methyl group) instead of ethylene glycol dimethacrylate used in Synthesis Example 1. The average particle size of the polymer particles 7 was 60 nm, and the Tg was −39° C.

The chemical structure of the polymer of the polymer particles 7 was analyzed by ¹³C-NMR. As a result, it was found that the polymer particles 7 consisted of 96.5 mol % of a constituent unit derived from the isodecyl methacrylate, and 3.5 mol % of a constituent unit derived from the dimethyl silicone oil having methacryloyloxy groups at the molecular ends.

### Synthesis Example 8: Polymer Particles 8

60 g of n-butyl acrylate, 4.325 g of polyethylene glycol diacrylate (“NK Ester A-200” manufactured by Shin-Nakamura Chemical Co. Ltd., having the formula (6) in which R⁶ is a hydrogen atom, R⁷ is an ethylene group, and n is 3), 13.50 g of sodium dodecyl sulfate, 126 g of water and 14 g of ethanol were mixed and stirred for one hour to emulsify the monomer, and 1.265 g of potassium persulfate was added to the emulsion. Thereafter, nitrogen bubbling was performed for one hour, and the solution was held at 70° C. for 8 hours. Methanol was added to the resulting solution to precipitate polymer particles by coagulation, and the polymer particles were dried in a vacuum drier under the conditions of 70° C. and 1.0×10³ Pa to obtain polymer particles 8. The average particle size of the polymer particles 8 was 60 nm, and the Tg was −50° C.

The chemical structure of the polymer of the polymer particles 8 was analyzed by ¹³C-NMR. As a result, it was found that the polymer particles 8 consisted of 97 mol % of a constituent unit derived from the n-butyl acrylate, and 3.0 mol % of a constituent unit derived from the polyethylene glycol diacrylate.

[Preparation and Evaluation of Rubber Composition]

Using a laboratory mixer and following the formulations (parts by mass) shown in Table 1 below, compounding ingredients other than sulfur and a vulcanization accelerator were first added to the diene rubber and the components were mixed and kneaded in a first mixing step (discharge temperature=160° C.). Subsequently, sulfur and the vulcanization accelerator were added to the resulting kneaded mixture and mixing and kneading of the components were performed in a final mixing step (discharge temperature=90° C.), thereby preparing a rubber composition.

The following are details of the components listed in Table 1.
Modified SBR: “HPR350” manufactured by JSR Corporation, which is a solution-polymerized SBR modified with an alkoxy group and an amino group at the molecular ends
BR: “UBEPOL BR150B” manufactured by OBE Industries, Ltd.
Silica: “Nipsil AQ” manufactured by Tosoh Silica Corporation
Silane coupling agent: Bis(3-triethoxysilylpropyl)tetrasulfide “Si69” manufactured by Evonik Industries
Zinc oxide: “Zinc Flower Type 1” manufactured by Mitsui Mining & Smelting Co., Ltd.
Antioxidant: “NOCRAC 6C” manufactured by Ouchi Shinko Chemical Industrial Co., Ltd.
Stearic acid: “LUNAC S-20” manufactured by Kao Corporation
Sulfur: “Powdered sulfur for rubber 150 mesh” manufactured by Hosoi Chemical Industry Co., Ltd.
Vulcanization accelerator: “NOCCELER CZ” manufactured by Ouchi Shinko Chemical Industrial Co., Ltd.
Secondary vulcanization accelerator: “NOCCELER D” manufactured by Ouchi Shinko Chemical Industrial Co., Ltd.
Polymer particles 1 to 8: the polymer particles synthesized in Synthesis Examples 1 to 8

Each of the rubber compositions obtained was vulcanized at 160° C. for 20 minutes to produce a specimen having a predetermined shape. For each of the specimens thus obtained, a dynamic viscoelasticity test was performed to measure the tan δ at 0° C. and the tan δ at 60° C. The measurements were performed by the following methods.
0° C. tan δ: Using “Rheospectrometer E4000” manufactured by UBM, a loss factor tan δ was measured under the conditions: frequency 10 Hz, static strain 10%, dynamic strain 2%, and temperature 0° C. The measured value is expressed as an index number relative to the value of Comparative Example 1 expressed as 100. A higher index number indicates a higher tan δ and superior wet grip performance.
60° C. tan δ: Measurement of tan δ was performed in the same manner as in the above “0° C. tan δ” measurement except for changing the temperature to 60° C. The measured value is expressed as an index number relative to the value of Comparative Example 1 expressed as 100. A lower index number indicates that the rubber composition generates less heat, and that the rubber composition provides a tire having lower rolling resistance and thus having superior rolling resistance performance (superior low-fuel consumption performance).

TABLE 1

| | Comp. | Comp. | Comp. | | | | | | |
|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 |
| Components | | | | | | | | | |
| (parts by mass) | | | | | | | | | |
| Modified SBR | 70 | 70 | 70 | 70 | 70 | 70 | 70 | 70 | 70 |
| BR | 30 | 30 | 30 | 30 | 30 | 30 | 30 | 30 | 30 |
| Silica | 70 | 70 | 70 | 70 | 70 | 70 | 70 | 70 | 70 |
| Silane coupling agent | 5.6 | 5.6 | 5.6 | 5.6 | 5.6 | 5.6 | 5.6 | 5.6 | 5.6 |
| Polymer particles 1 | — | 10 | — | — | — | — | — | — | — |
| Polymer particles 2 | — | — | 10 | — | — | — | — | — | — |
| Polymer particles 3 | — | — | — | 10 | — | — | — | — | — |
| Polymer particles 4 | — | — | — | — | 10 | — | — | — | — |
| Polymer particles 5 | — | — | — | — | — | 10 | — | — | — |
| Polymer particles 6 | — | — | — | — | — | — | 10 | — | — |
| Polymer particles 7 | — | — | — | — | — | — | — | 10 | — |
| Polymer particles 8 | — | — | — | — | — | — | — | — | 10 |
| Zinc oxide | 2 | 2 | 2 | 2 | 2 | 2 | 2 | 2 | 2 |
| Antioxidant | 2 | 2 | 2 | 2 | 2 | 2 | 2 | 2 | 2 |
| Stearic acid | 2 | 2 | 2 | 2 | 2 | 2 | 2 | 2 | 2 |
| Sulfur | 1.8 | 1.8 | 1.8 | 1.8 | 1.8 | 1.8 | 1.8 | 1.8 | 1.8 |
| Vulcanization | 1.8 | 1.8 | 1.8 | 1.8 | 1.8 | 1.8 | 1.8 | 1.8 | 1.8 |
| accelerator | | | | | | | | | |
| Secondary | 1.5 | 1.5 | 1.5 | 1.5 | 1.5 | 1.5 | 1.5 | 1.5 | 1.5 |
| vulcanization | | | | | | | | | |
| accelerator | | | | | | | | | |
| Physical properties | | | | | | | | | |
| (index) | | | | | | | | | |
| 0° C. tan δ | 100 | 135 | 148 | 146 | 150 | 147 | 147 | 145 | 146 |
| 60° C. tan δ | 100 | 100 | 100 | 94 | 92 | 94 | 95 | 95 | 93 |

The results are shown in Table 1. The results indicate the following: Compared to the rubber composition of Comparative Example 1 which serves as a control, the rubber composition of Comparative Example 2 which contains the polymer particles 1 can significantly enhance the wet grip performance while maintaining the rolling resistance performance. The rubber composition of Comparative Example 3, which contains the polymer particles 2 having a longer crosslinking chain than that of the polymer particles 1, can further enhance the wet grip performance. Compared to the rubber composition of Comparative Example 1, the rubber compositions of Examples 1 to 6, which contain the polymer particles 3 to 8 each having a crosslinked structure into which an ether bond or a siloxane bond has been introduced, can significantly improve the wet grip performance while improving the rolling resistance performance. Also compared Lo the rubber compositions of Comparative Examples 2 and 3, the rubber compositions of Examples 1 to 6 can achieve an improvement in the conflicting properties.

What is claimed is:

1. Polymer particles comprising a (meth)acrylate polymer having a constituent unit represented by the following general formula (1) and having a chemically crosslinked structure containing an ether bond or a siloxane bond: 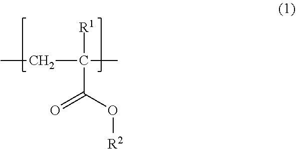
wherein R¹ represents a hydrogen atom or a methyl group, and R¹s in the same molecule may be the same as or different from each other; and R² represents an alkyl group having 4 to 18 carbon atoms, and Res in the same molecule may be the same as or different from each other.

2. The polymer particles according to claim 1, having a glass transition point of not less than −70° C. and not more than 0° C., and an average particle size of 10 to 100 nm.

3. The polymer particles according to claim 1, wherein the crosslinked structure comprises a structure represented by the following general formula (2): 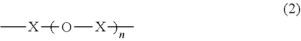
wherein X represents an alkylene group having 2 to 6 carbon atoms, or —SiR³R⁴—, and Xs in the same molecule may be the same as or different from each other, R³ and R⁴ each independently represent a hydrogen atom or an alkyl group having 1 to 3 carbon atoms, and n is an integer of 1 to 35.

4. The polymer particles according to claim 3, wherein X in the general formula (2) represents an alkylene group having 2 to 6 carbon atoms, and n is an integer of 1 to 20.

5. The polymer particles according to claim 3, wherein X in the general formula (2) represents —SiR³R⁴—, and n is an integer of 5 to 35.

6. The polymer particles according to claim 1, wherein the (meth)acrylate polymer comprises, together with the constituent unit represented by the general formula (1), a constituent unit derived from a polyfunctional vinyl monomer having an ether bond or a siloxane bond, and has the crosslinked structure in which the constituent unit derived from the polyfunctional vinyl monomer constitutes a crosslinking point.

7. The polymer particles according to claim 6, wherein the polyfunctional vinyl monomer comprises a polyalkylene glycol di(meth)acrylate and/or a silicone oil having (meth)acryloyloxy groups at both ends of the molecule.

8. The polymer particles according to claim 6, wherein the polyfunctional vinyl monomer comprises a polyalkylene glycol di(meth)acrylate represented by the following general formula (6): 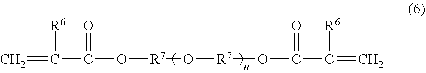
wherein R⁶ represents a hydrogen atom or a methyl group, and R⁶s in the same molecule may be the same as or different from each other; R⁷ represents an alkylene group having 2 to 6 carbon atoms, and R⁷s in the same molecule may be the same as or different from each other; and n is an integer of 1 to 35.

9. The polymer particles according to claim 6, wherein the polyfunctional vinyl monomer comprises a silicone oil having (meth)acryloyloxy groups at both ends of the molecule, represented by the following general formula (7): 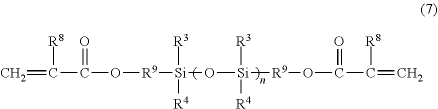
wherein R³ and R⁴ each independently represent a hydrogen atom or an alkyl group having 1 to 3 carbon atoms, and R³s and R⁴s in the same molecule may respectively be the same as or different from each other; R⁸ represents a hydrogen atom or a methyl group, and R³s in the same molecule may be the same as or different from each other; R⁹ represents a divalent organic group, and R⁹s in the same molecule may be the same as or different from each other; and n is an integer of 1 to 35.

10. A rubber composition comprising 100 parts by mass of a rubber component comprising a diene rubber, and 1 to 100 parts by mass of the polymer particles according to claim 1.

11. A tire comprising a tread rubber comprising the rubber composition according to claim 10.
